(19) United States
(12) Patent Application Publication
(10) Pub. No.: US 2012/0309612 A1
(43) Pub. Date: Dec. 6, 2012

(54) MAGNETIC CATALYST

(75) Inventors: Chan-Li HSUEH, Qieding Township (TW); Cheng-Hong LIU, Chiayi City (TW); Jie-Ren KU, Kaohsiung City (TW); Ya-Yi HSU, Guiren Township (TW); Cheng-Yen CHEN, Yongkang City (TW); Reiko OHARA, Tainan City (TW); Shing-Fen TSAI, Xinshi Township (TW); Chien-Chang HUNG, Pingtung City (TW); Ming-Shan JENG, Sijhih City (TW)

(73) Assignee: INDUSTRIAL TECHNOLOGY RESEARCH INSTITUTE, Hsinchu (TW)

(21) Appl. No.: 13/572,089

(22) Filed: Aug. 10, 2012

Related U.S. Application Data
(63) Continuation of application No. 12/502,603, filed on Jul. 14, 2009.

(30) Foreign Application Priority Data
May 8, 2009 (TW) 98115299

(51) Int. Cl. B01J 31/08; B01J 23/89; B01J 23/755; B01J 23/745; B01J 23/75

(52) U.S. Cl. 502/159; 502/338; 502/325; 502/337; 502/326

(57) ABSTRACT

Disclosed is a magnetic catalyst formed by a single or multiple nano metal shells wrapping a carrier, wherein at least one of the metal shells is iron, cobalt, or nickel. The magnetic catalyst with high catalyst efficiency can be applied in a hydrogen supply device, and the device can be connected to a fuel cell. Because the magnetic catalyst can be recycled by a magnet after generating hydrogen, the practicability of the noble metals such as Ru with high catalyst efficiency is dramatically enhanced.

### CROSS REFERENCE TO RELATED APPLICATIONS

This application is a Continuation of pending U.S. patent application Ser. No. 12/502,603, filed on Jul. 14, 2009 and entitled “Magnetic catalyst and method for manufacturing the same”, which claims priority of Taiwan Patent Application No. 98115299, filed on May 8, 2009, the entirety of which is incorporated by reference herein.

### TECHNIQUE FIELD

The disclosure relates to a hydrogen releasing catalyst, and in particular relates to the magnetic hydrogen releasing catalyst and the application thereof.

### BACKGROUND

One major trend of green energy development is hydride for releasing hydrogen. The catalysts of a hydrogen releasing mechanism can be roughly categorized as noble metals such as ruthenium (Ru), palladium (Pd), platinum (Pt), and the likes, or non-noble metals such as copper (Cu), iron (Fe), cobalt (Co), nickel (Ni), and the likes. As for noble metals, mass production thereof is hindered due to high costs. If the used catalyst can be unified and conveniently recycled by specific method, it will be reused to reduce the cost. Also, currently, there is no commercially available catalyst for hydride to release hydrogen. There are several noble metal catalyst preparations which have been disclosed to collocate with a fuel cell which is applied in small electronic products. However, commercialization is hindered by high cost and lack of lower cost solutions, such as recycling.

U.S. Pub. No. 2006/0292067 discloses a catalyst carrier using nickel. Several kinds of metal are grown on a carrier to prepare a multi-metal composite catalyst. The metals include cobalt, ruthenium, zinc, manganese, titanium, tin, chromium, and the likes. In forming the catalyst carrier, 50 g of a composite of 50% sintered nickel powder and 50% compressed nickel fiber is cut to a square plate (0.25 inch*0.25 inch). 6.31 g of CoCl₂.6H₂O and 1.431 g of RuCl₃.H₂O are weighted and dissolved to form a metal salt solution (about 30 mL). The nickel square plate is dipped in a metal salt solution, and heated to 70° C. to gradually evaporate the water. After the water is evaporated, different ratios of CoCl₂.6H₂O and RuCl₃.H₂O are deposited on the nickel carrier. The nickel carrier with metal salt surface deposits is charged in a furnace for sintering at 240° C. To reduce metal ion, the 20 mL/min of hydrogen is simultaneously and continuously introduced into the furnace for 3 hours. Thereafter, the composite catalyst of ruthenium (1.2 wt %) and cobalt (3 wt %) is completed. The composite catalyst can be applied in a boron hydride solution to release hydrogen. The bi-metal composite catalyst prepared by high temperature sintering has a hydrogen release rate of about 37 mL/minute.g in a solution of 3 wt % sodium hydroxide and 20 wt % boron hydride. If the metal composite catalyst is fastened in a fixed bed to react with 200mL of a solution (3 wt % sodium hydroxide and 20 wt % boron hydride) at a flow rate of 20 g/minute, and at pressure of 55 to 88 psig for 6 to 8 hours, the conversion ratio of the hydrogen releasing may reach 90%. According to the relationship of time versus temperature, enhancing the pressure may shorten the system initiating time. Although the metal composite catalyst has a fast initiating time for hydrogen release in the boron hydride solution, its preparation needs high temperatures. Furthermore, the prepared catalyst has no magnetic properties.

Taiwan Pat. No. 079936 discloses a promoted nickel and/or cobalt catalyst, application thereof, and a process utilizing the same. For forming the catalyst, a carrier is dipped in an RuCl₃.H₂O solution, wherein the carrier is an activated aluminum oxide having an internal surface area of 10 to 1000 m² g⁻¹ and coated by 4 wt % to 40 wt % nickel or cobalt metal oxide. After dipping, the catalyst intermediate is dried and blown by hydrogen at 200° C. to 300° C., such that ruthenium ion is reduced to ruthenium metal and the nickel/cobalt oxide is optionally reduced to nickel/cobalt metal to complete the catalyst used in dehydrogenation and/or hydrogenation. However, preparation also needs high temperatures and the aluminum oxide carrier easily collapses in high alkalinity conditions.

For solving the high temperature sintering problem during preparation, inventors of this disclosure have disclosed a method in Taiwan Appl. No. 96150963. In the application, the nano ruthenium catalyst is grown on the polymer carrier surface by ion exchange at room temperature. Thus, high temperature preparation is not needed. However, the ruthenium catalyst is still not magnetic.

Accordingly, a novel hydrogen releasing catalyst is called to improve recycling properties.

### SUMMARY

One embodiment of the disclosure provides a magnetic catalyst, comprising: a carrier consisting of strong-acid or weak-acid cationic exchange resin, metal, or surface activated non-metal; a first nano metal shell wrapping and contacting a surface of the carrier; and a second nano metal shell wrapping the first nano metal shell, wherein the first and second nano metal shells have different compositions, and at least one of the first and second nano metal shells consists of iron, cobalt, or nickel, wherein the magnetic catalyst is contained in a hydrogen supply device to release hydrogen, and the hydrogen supply device is connected to a fuel cell, wherein the first and second nano metal shells are shells containing metal with a nanosize respectively.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a magnetic analysis diagram of the magnetic catalyst in one embodiment of the disclosure;

FIG. 2 is a thermo gravity analysis diagram of the cobalt amount chelated on the magnetic catalyst surface in one embodiment of the disclosure;

FIG. 3 shows the relationship between hydrogen releasing rate versus temperature of the magnetic catalyst in an NaBH₄ solution in one embodiment of the disclosure;

FIG. 4 shows the relationship between hydrogen releasing rate versus time of the magnetic catalyst in an NaBH₄ solution in one embodiment of the disclosure;

FIGS. 5A-5D show the relationships between hydrogen releasing rate versus time of the recycled magnetic catalysts in an NaBH₄ solution in one embodiment of the disclosure;

FIGS. 6A-6D show the relationships between hydrogen releasing amount versus time of the recycled magnetic catalysts in an NaBH₄ solution in one embodiment of the disclosure;

FIG. 7 is a magnetic analysis diagram of the magnetic catalyst in one embodiment of the disclosure;

FIG. 8 shows the relationship between hydrogen releasing rate versus time of the magnetic catalyst in an NaBH₄ solution of different concentration in one embodiment of the disclosure;

FIGS. 9A-9D show the relationships between hydrogen releasing rate versus time of the recycled magnetic catalysts in an NaBH₄ solution in one embodiment of the disclosure; and

FIGS. 10A-10D show the relationships between hydrogen releasing amount versus time of the recycled magnetic catalysts in an NaBH₄ solution in one embodiment of the disclosure.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

The disclosure adopts a chemical reducing and/or electroless plating process to form magnetic catalysts having a single or multi layered nano metal shell.

First, a cationic exchange resin having strong acid (e.g. —SO₃H) or weak acid (e.g. COOH) groups on the surface is provided as a carrier. In one embodiment, the cationic exchange resin is ball-like with a diameter of about 100 μm to 200 μm. A suitable cationic exchange resin of the disclosure can be Amberlite IR-120 in hydrogen form commercially available from Supelco Chemical Co. (Bellefonte, Pa., USA) or Dowex® 50WX8 in hydrogen form commercially available from Dow Chemicals. In one embodiment, the cationic exchange resin can be other manners such as pillar-like, plate-like, or other general catalyst manners (e.g. porous zeolite).

The cationic exchange resin is added to a metal salt solution and stirred to chelate the metal ion to the acidic function groups on the resin surface. The metal salts include iron, cobalt, or nickel ions, and they become magnetic atom type after reduction. The metal salt solution concentration depends on the resin weight, and its concentration is one to five times the theoretical chelate amount. If the concentration is lower than this range, the chelate amount will be insufficient.

Subsequently, the resin is washed by deionized water to remove the unchelated metal ion. This step may improve the dispersity of the metal ion on the resin surface.

The washed resin is charged in a reducing agent solution, such that the chelated metal ion is reduced to atom type. As such, the nano metal shell of iron, cobalt, or nickel is formed to wrap the resin surface. The reducing agent includes sodium boronhydride, potassium boronhydride, dimethylamino borane, B₂O₆, hydrazine, formaldehyde, formic acid, sulfite, sodium hypophosphite, glucose, or sodium citrate.

The carrier of the disclosure is not only the cationic exchange resin, but also metal (such as stainless web, nickel web, or brass sheet) or surface activated non-metal (such as silicon dioxide, carbonanotube, or polymer). The non-metal surface can be activated by plasma or SnCl₂/PdCl₂ solution. The consideration for shape and the size of the metal and non-metal materials are similar to the described cationic exchange resin. The electroless plating solution is prepared as below. The metal salts of iron, cobalt, or nickel, the sodium citrate, and the maleic acid are dissolved to form a solution. The solution is added NaOH_{(aq)} to tune its pH value to 9.5, heated to 80° C., and added a little reducing agent to complete the electroless plating solution. The metal or surface activated non-metal is added to the electroless plating solution to react and form a magnetic catalyst, wherein the thickness of the single-layered nano metal shell is controlled by the reaction time.

In addition to the single-layered magnetic catalyst, the disclosure may further form bi-layered or multi-layered magnetic catalysts by the electroless plating process.

First, the described cationic exchange resin, metal, or surface activated non-metal is provided as carrier. The carrier surface is then wrapped by a nano metal shell such as copper, iron, cobalt, nickel, ruthenium, palladium, or platinum, by described chemical reducing or electroless plating.

The electroless plating solution is prepared as follows. The metal salts of copper, iron, cobalt, nickel, ruthenium, palladium, or platinum, the sodium citrate, and the maleic acid are dissolved to form a solution. The solution is added NaOH_{(aq)} to tune its pH value to 9.5, heated to 80° C., and added a little reducing agent to complete the electroless plating solution.

The carrier having a surface wrapped by the nano metal shell is added to the electroless plating solution to react for forming another nano metal shell wrapping the original nano metal shell. The magnetic catalyst is washed to remove residue solvent and dried to complete a magnetic catalyst having a bi-layered nano metal shell. Note that at least one of the inner and outer shells must be magnetic metal such as iron, cobalt, or nickel to form the magnetic catalyst. The catalyst has both advantages of the two metals. For example, ruthenium is the most efficient hydrogen releasing catalyst known and iron, cobalt, and nickel are magnetic. The magnetic catalyst prepared by the method of the disclosure, having the nano nickel inner-shell and the nano ruthenium outer-shell, will simultaneously have the advantages of fast hydrogen releasing rate and being magnetic. In another embodiment, the magnetic catalyst has the nano ruthenium inner-shell and the nano nickel outer-shell, and the nickel outer-shell only partially wraps the ruthenium inner-shell to prevent decreasing the catalyst effect of the ruthenium.

Furthermore, the magnetic catalyst having tri-layered, terta-layered, or more layered nano metal shells can be prepared by repeating the electroless plating process. However, because diminished catalyst activity for the wrapped part of the inner metal shell, the shell number is preferably less than five.

The magnetic catalyst can be applied in a hydrogen supply device. The hydrogen supply device with the magnetic catalyst of the disclosure has stable hydride solution in an alkalinity condition therein, and releases hydrogen after the magnetic catalyst of the disclosure is added. The hydride solution includes LiAlH₄, NaAlH₄, Mg(AlH₄)₂, Ca(AlH₄)₂, LiBH₄, NaBH₄, KBH₄, Be(BH₄)₂, Mg(BH₄)₂, Ca(BH₄)₂, LiH, NaH, MgH₂, or CaH₂. In one embodiment, the hydride is a mild hydride such as NaBH₄, KBH₄, NH₃BH₃, and the likes. Other hydrides reacting violently with water are used to assist an initial hydrogen releasing rate, and not for stable and long-term hydrogen releasing rate purposes

The described hydrogen supply device can be further connected to a fuel cell or other device needing hydrogen. The magnetic catalyst is easily recycled by a magnet after use. The recycled magnetic catalyst is ready to be reused after simply washing the catalyst surface to remove the deposition from the hydride.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

30 g of a cationic exchange resin (IR-120, commercially available from Supelco Chemical Co.) was added to a cobalt chloride solution (CoCl₂.6H₂O, 8.992 g/dL), and stirred for 60 rpm at room temperature, such that the acidic function of the resin surface chelated the cobalt ion. The unchelated cobalt ion on the resin surface was then washed by deionized water. The washed resin was added to an NaBH₄ solution to reduce chelated cobalt ion, thereby forming a nano cobalt shell wrapping the resin surface. The resin was then washed by deionized water and dried at room temperature, and analyzed by SEM and XPS to determine the magnetic catalyst having a single-layered nano cobalt shell.

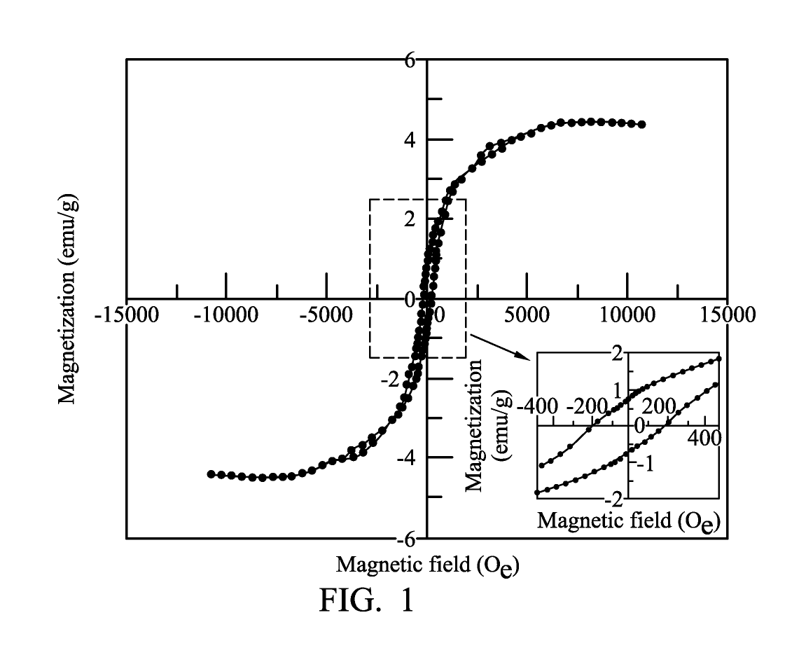

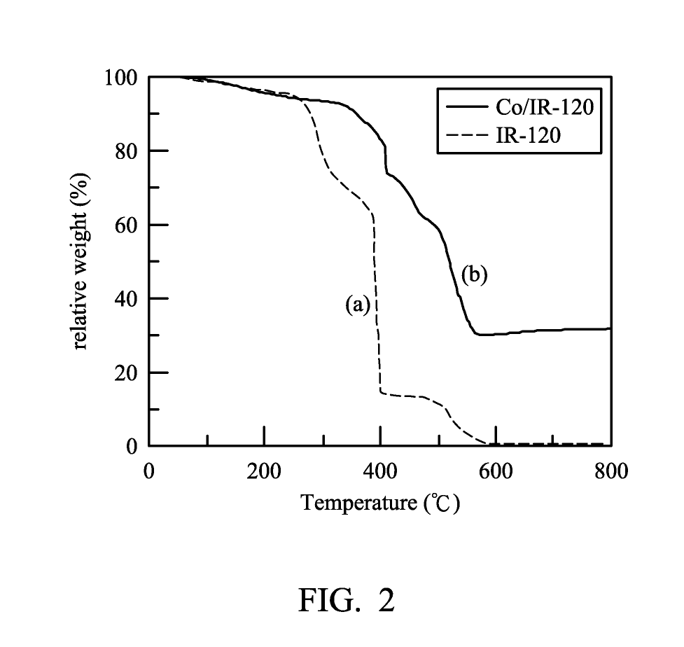

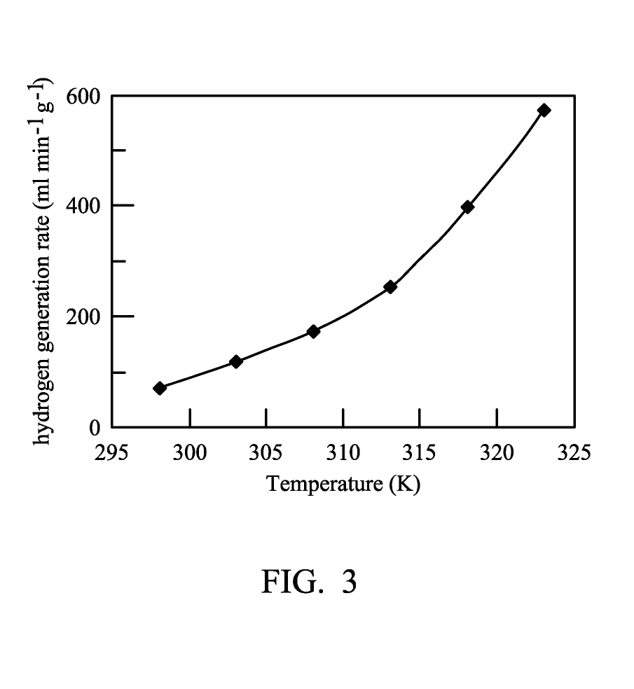

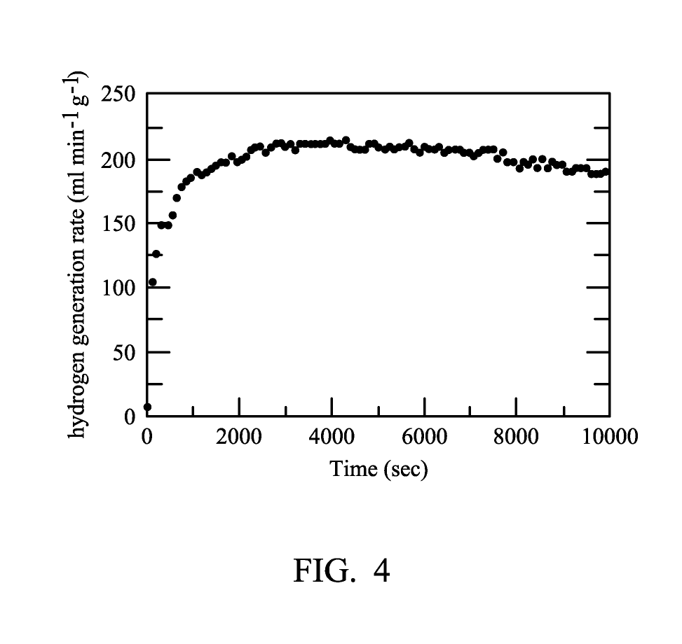

The magnetic performance of the catalyst was shown in FIG. 1. As shown in FIG. 2, the chelated cobalt amount on the catalyst surface was about 30%. While the magnetic catalyst was added in 1.32N of the NaBH₄ solution, the hydrogen releasing reaction occurred in different rates at different temperatures as shown in FIG. 3. The hydrogen releasing system without control of the temperature thereof had a rate versus time relation as shown in FIG. 4.

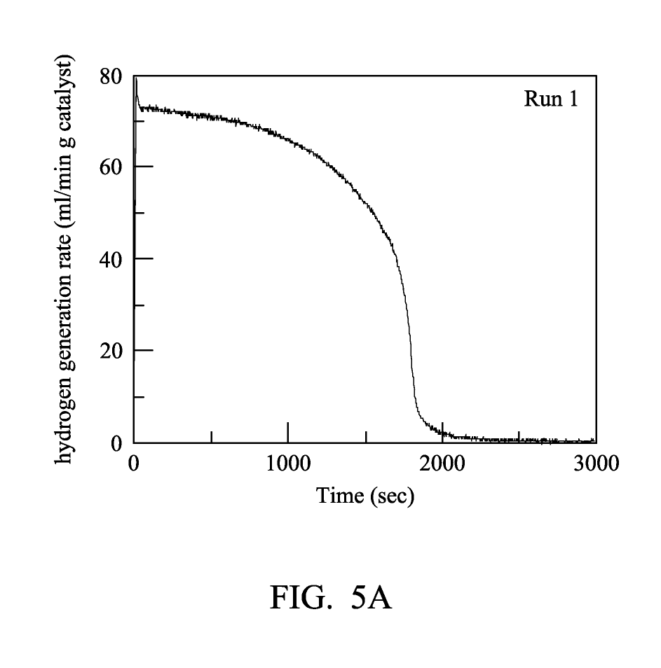

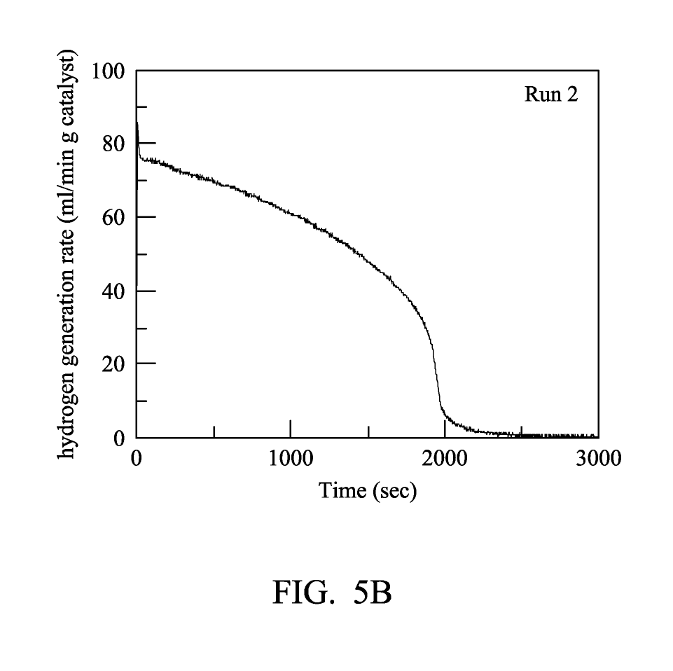

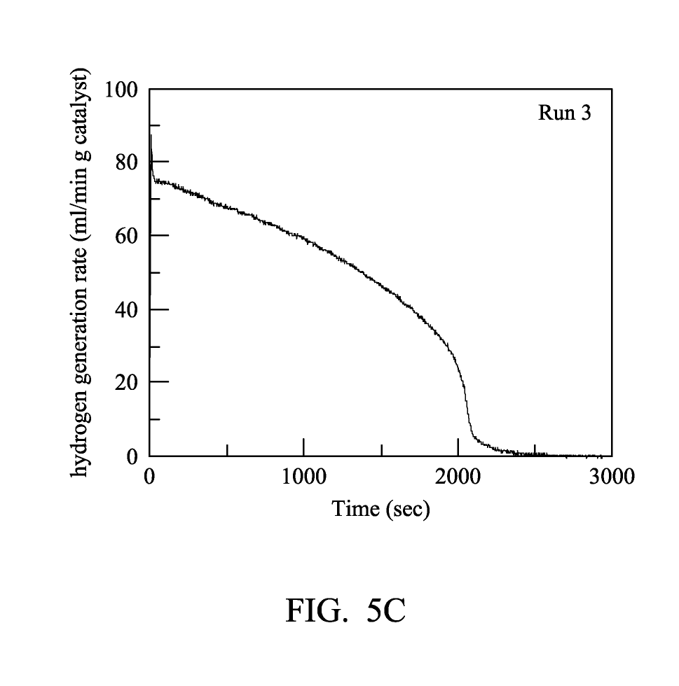

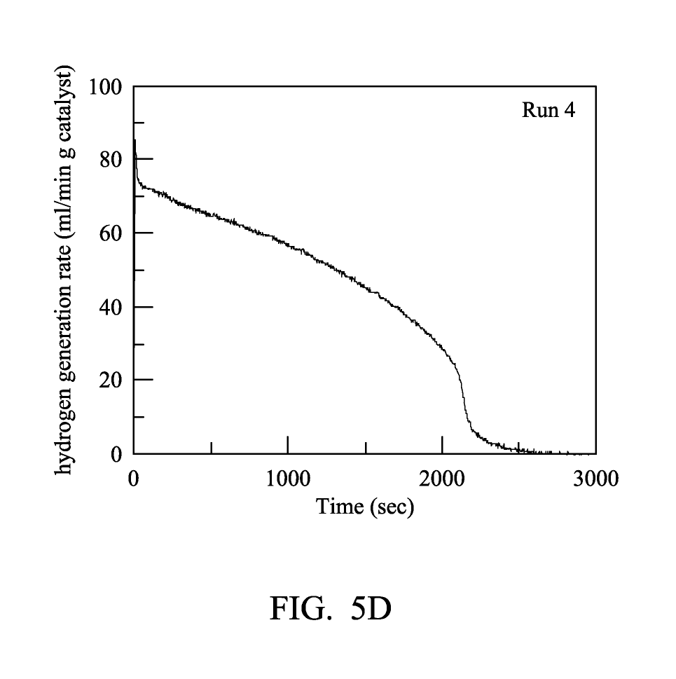

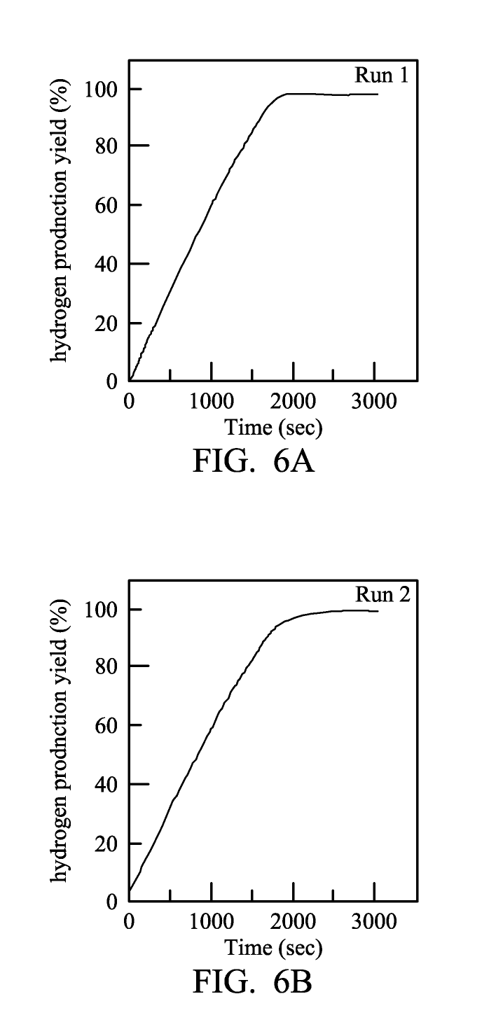

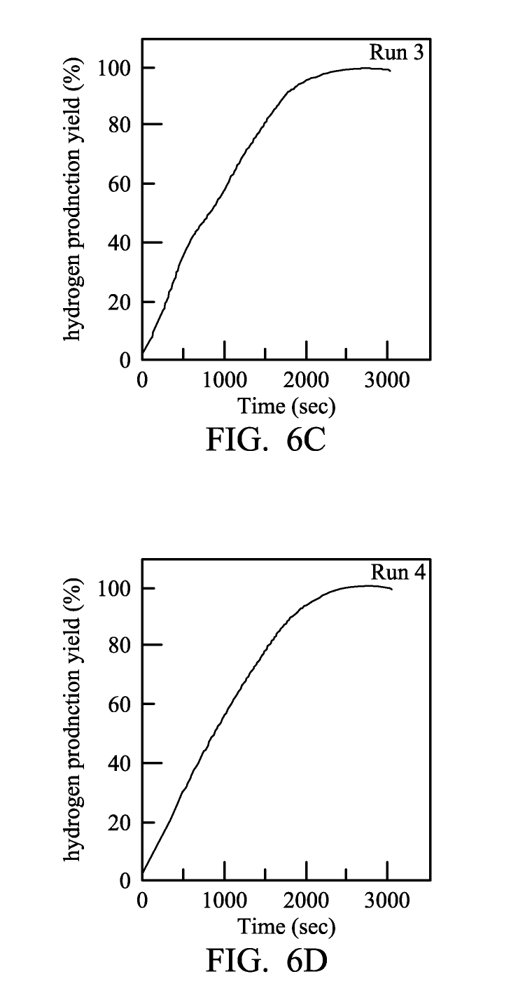

The magnetic catalyst was recycled after the hydrogen releasing reaction was completed. The recycled magnetic catalyst was washed by deionized water to repeat the described hydrogen releasing reaction. As shown in FIGS. 5A-5D, the first hydrogen releasing reaction (FIG. 5A), the second hydrogen releasing reaction after the magnetic catalyst was recycled once (FIG. 5B), the third hydrogen releasing reaction after the magnetic catalyst was recycled twice (FIG. 5C), and the fourth hydrogen releasing reaction after the magnetic catalyst was recycled three times (FIG. 5D) all had similar hydrogen releasing rate. As shown in FIGS. 6A-6D, the first hydrogen releasing reaction (FIG. 6A), the second hydrogen releasing reaction after the magnetic catalyst was recycled once (FIG. 6B), the third hydrogen releasing reaction after the magnetic catalyst was recycled twice (FIG. 6C), and the fourth hydrogen releasing reaction after the magnetic catalyst was recycled three times (FIG. 6D) all had almost 100% hydrogen releasing amount before 2000 seconds of the hydrogen releasing reaction.

Example 2

25 g of a cationic exchange resin (50WX8, commercially available from Dow Chemicals) was added to 0.25 L of a ruthenium chloride solution (RuCl₃.xH₂O , 2 g/dL), and stirred for 60 rpm at room temperature, such that the acidic function of the resin surface chelated the ruthenium ion. The unchelated ruthenium ion on the resin surface was then washed by deionized water. The washed resin was added to an NaBH₄ solution to reduce chelated ruthenium ion, thereby forming a nano ruthenium shell wrapping the resin surface. The resin was then washed by deionized water and dried at room temperature, and analyzed by SEM and XPS to determine the magnetic catalyst having a single-layered nano ruthenium shell.

Subsequently, 2.62 g/dL of NiCl₂.H₂O, 4 g/dL of sodium citrate (Na₃C₆H₅O₇.2H₂O) as a complexing agent, and 0.8 g/dL of maleic acid as a protective agent were weighted and dissolved in water to form 0.1 L of a solution. The solution was added NaOH_{(aq)} or NH_{3(aq)} to tune its pH value to 8.5 to 9.5, heated to 80° C., and added 2.5 mL/dL of hydrazine (N₂H₄.H₂O) as a reducing agent to complete the electroless plating solution.

The magnetic catalyst having a single-layered nano ruthenium shell was added to the electroless plating solution to react for 60 minutes, thereby forming a nano nickel shell on the nano ruthenium shell. The resin was then washed by deionized water and dried at room temperature, and analyzed by SEM and XPS to determine the magnetic catalyst having a bi-layered nano ruthenium-nickel shell.

Subsequently, 2.62 g/dL of RuCl₃.H₂O, 4 g/dL of sodium citrate (Na₃C₆H₅O₇.2H₂O) as a complexing agent, and 0.8 g/dL of maleic acid as a protective agent were weighted and dissolved in water to form 0.1L of a solution. The solution was added NaOH_{(aq)} or NH_{3(aq)} to tune its pH value to 8.5 to 9.5, heated to 80° C., and added 2.5 mL/dL of hydrazine (N₂H₄.H₂O) as a reducing agent to complete the electroless plating solution.

The magnetic catalyst having a bi-layered nano ruthenium-nickel shell was added to the electroless plating solution to react for 60 minutes, thereby forming a nano ruthenium shell on the nano nickel shell. The resin was then washed by deionized water and dried at room temperature, and analyzed by SEM and XPS to determine the magnetic catalyst having a tri-layered nano ruthenium-nickel-ruthenium shell.

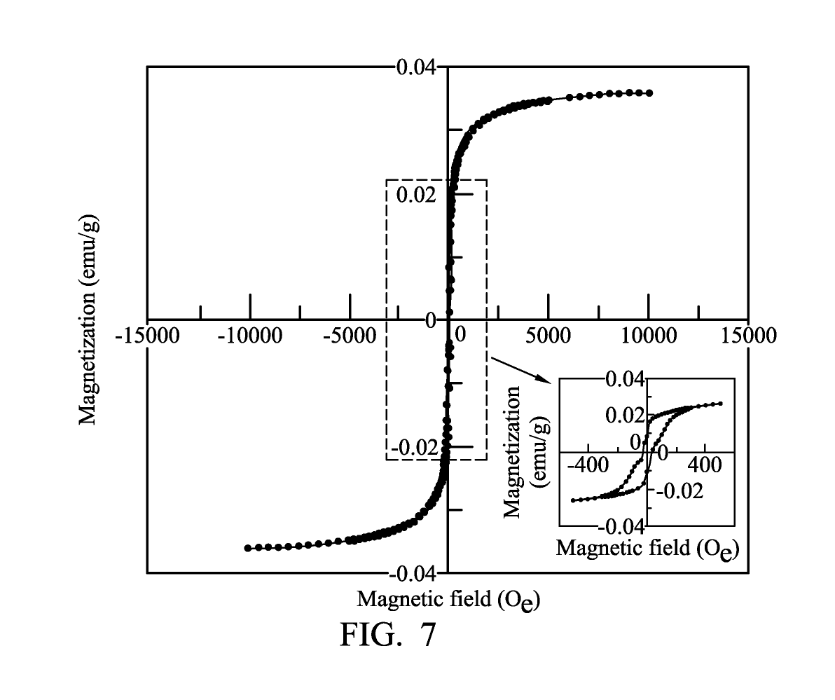

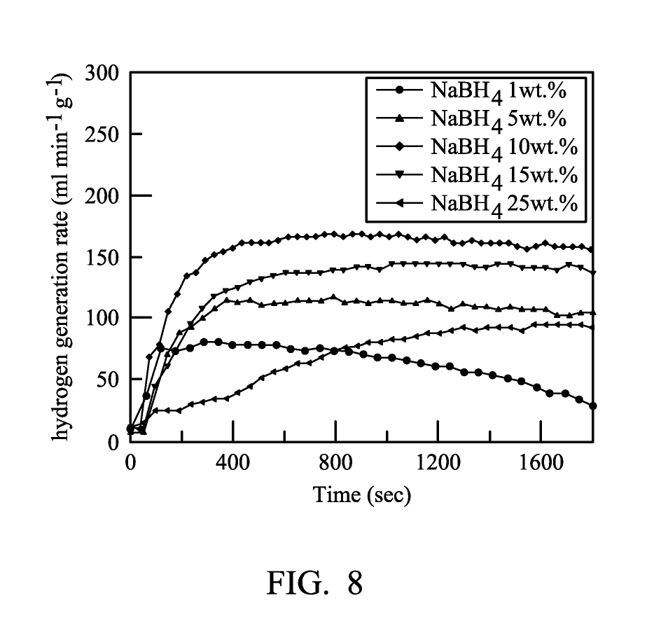

The magnetic performance of the catalyst was shown in FIG. 7. While the magnetic catalyst was added in 1 wt % to 25 wt % of an NaBH₄ solution, a stable hydrogen releasing reaction occurred as shown in FIG. 8.

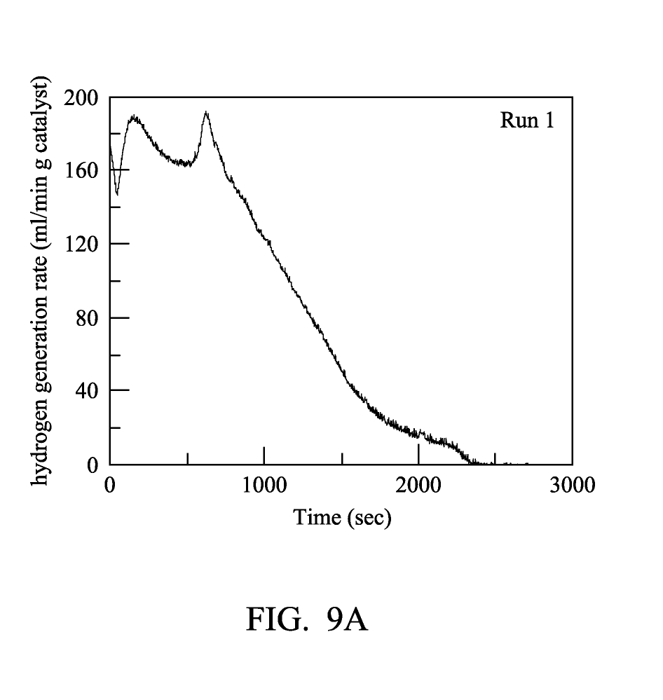

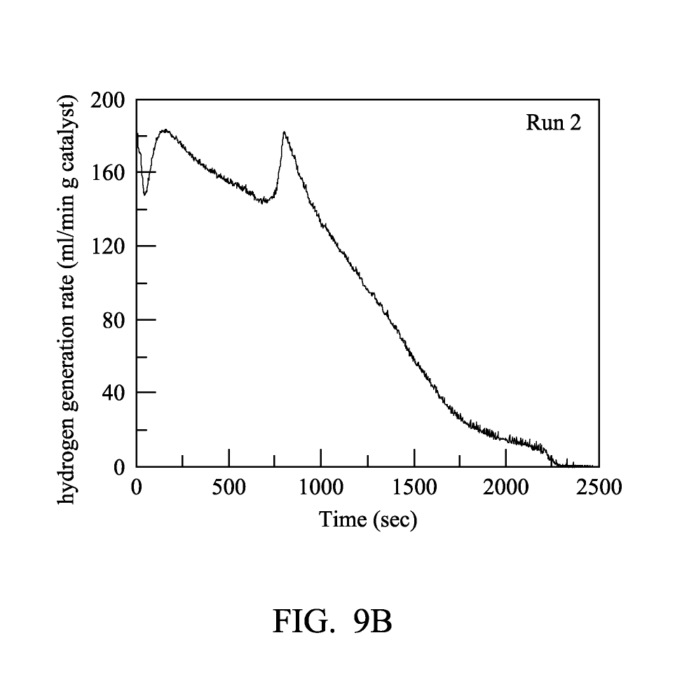

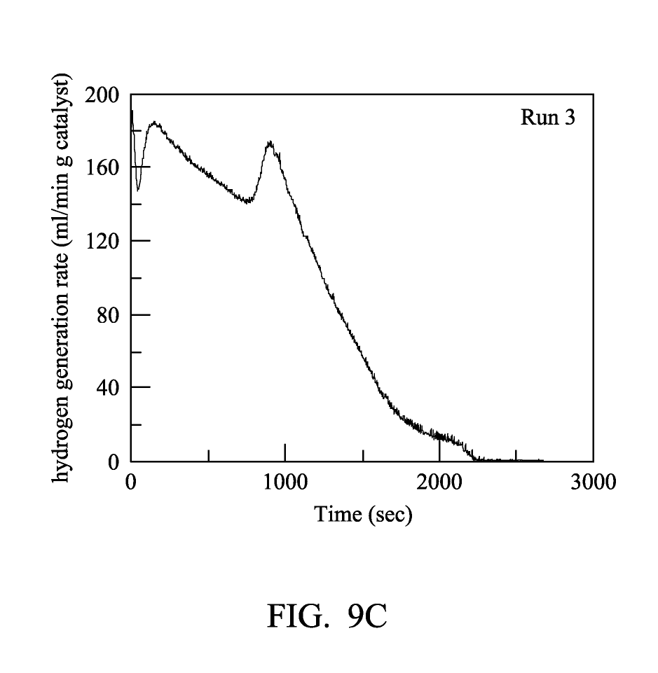

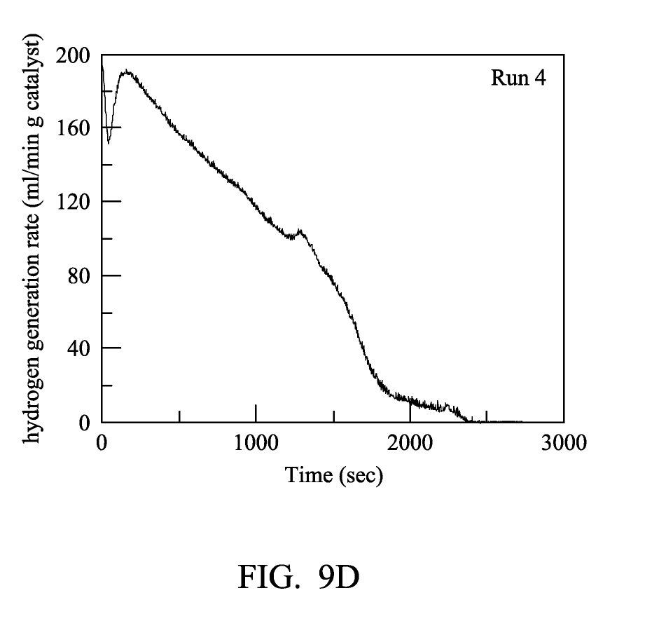

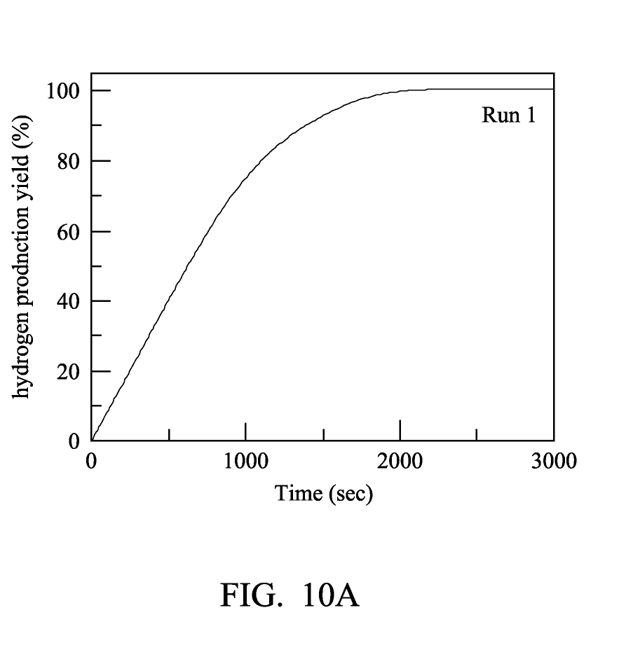

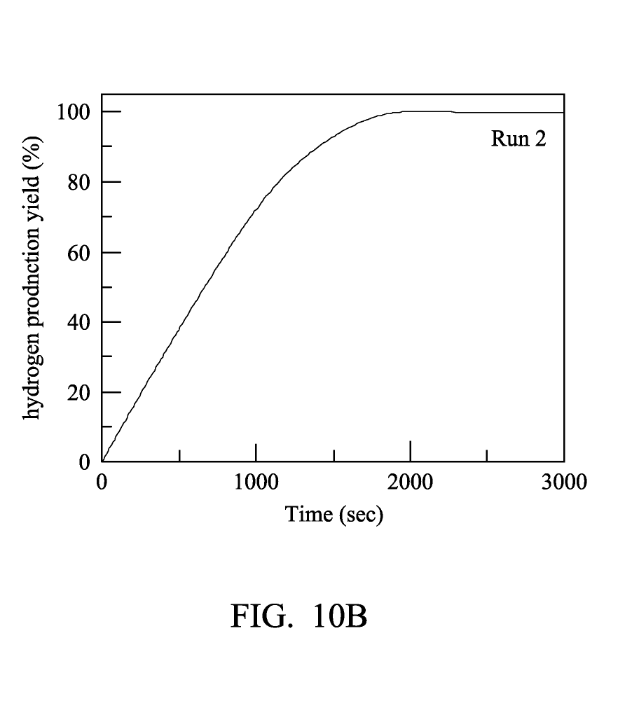

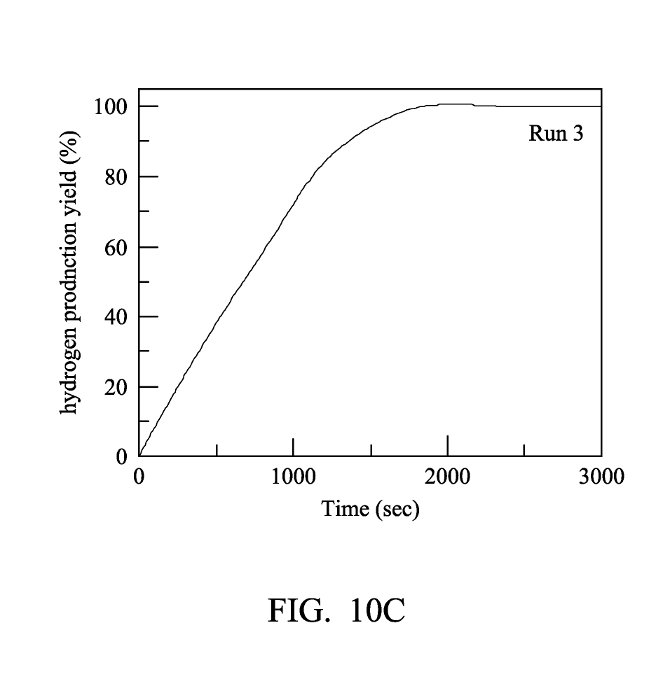

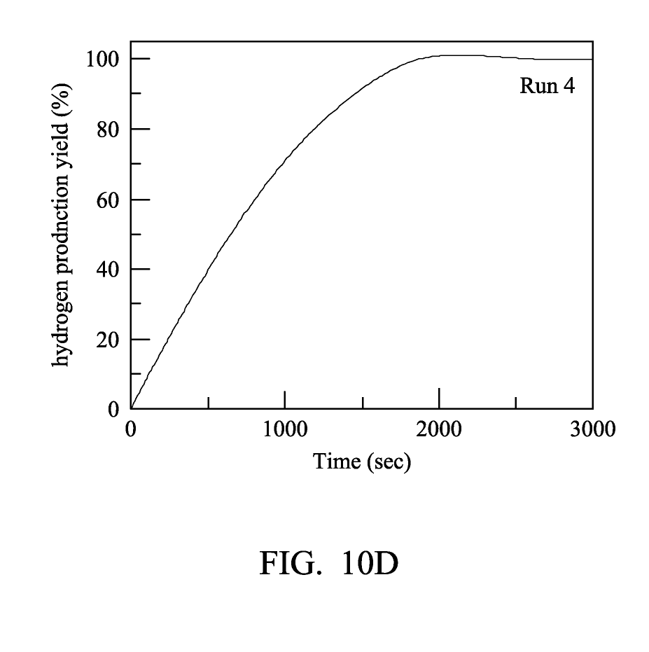

The magnetic catalyst was recycled after the hydrogen releasing reaction. The recycled magnetic catalyst was washed by deionized water to repeat the described hydrogen releasing reaction. As shown in FIGS. 9A-9D, the first hydrogen releasing reaction (FIG. 9A), the second hydrogen releasing reaction after the magnetic catalyst was recycled once (FIG. 9B), the third hydrogen releasing reaction after the magnetic catalyst was recycled twice (FIG. 9C), and the fourth hydrogen releasing reaction after the magnetic catalyst was recycled three times (FIG. 9D) all had similar hydrogen releasing rate. As shown in FIGS. 10A-10D, the first hydrogen releasing reaction (FIG. 10A), the second hydrogen releasing reaction after the magnetic catalyst was recycled once (FIG. 10B), the third hydrogen releasing reaction after the magnetic catalyst was recycled twice (FIG. 10C), and the fourth hydrogen releasing reaction after the magnetic catalyst was recycled three times (FIG. 10D) all had almost 100% hydrogen releasing amount before 2000 seconds of the hydrogen releasing reaction.

It will be apparent to those skilled in the art that various modifications and variations can be made to the disclosed methods and materials. It is intended that the specification and examples be considered as exemplary only, with a true scope of the disclosure being indicated by the following claims and their equivalents.

What is claimed is:

1. A magnetic catalyst, comprising:
a carrier consisting of strong-acid or weak-acid cationic exchange resin, metal, or surface activated non-metal;
a first nano metal shell wrapping and contacting a surface of the carrier; and
a second nano metal shell wrapping the first nano metal shell,
wherein the first and second nano metal shells have different compositions, and at least one of the first and second nano metal shells consists of iron, cobalt, or nickel,
wherein the magnetic catalyst is contained in a hydrogen supply device to release hydrogen, and the hydrogen supply device is connected to a fuel cell,
wherein the first and second nano metal shells are shells containing metal with a nanosize respectively.

2. The magnetic catalyst as claimed in claim 1, wherein the first nano metal shell is iron.

3. The magnetic catalyst as claimed in claim 1, wherein the first nano metal shell is cobalt.

4. The magnetic catalyst as claimed in claim 1, wherein the first nano metal shell is nickel.

5. The magnetic catalyst as claimed in claim 2 wherein the second nano metal shell consists of ruthenium.

6. The magnetic catalyst as claimed in claim 1, wherein the carrier is strong-acid or weak-acid cationic exchange resin.

7. The magnetic catalyst as claimed in claim 1, wherein one of the first and second nano metal shells consists of ruthenium.

8. The magnetic catalyst as claimed in claim 3 wherein the second nano metal shell consists of ruthenium.

9. The magnetic catalyst as claimed in claim 4 wherein the second nano metal shell consists of ruthenium.
